(19) United States
(12) Patent Application Publication
(10) Pub. No.: US 2023/0244328 A1
(43) Pub. Date: Aug. 3, 2023

(54) METHOD FOR OPERATING AN INPUT DEVICE, AND INPUT DEVICE

(71) Applicant: INVENTUS Engineering GmbH, St. Anton i.M. (AT)

(72) Inventors: Stefan Battlogg, St. Anton i.M. (AT); Markus Mayer, Sulz (Vorarlberg) (AT)

(21) Appl. No.: 18/013,025

(22) PCT Filed: Jun. 26, 2021
(86) PCT No.: PCT/EP2021/067592

§ 371 Date: Dec. 27, 2022

(30) Foreign Application Priority Data
Jun. 26, 2020 (DE) 10 2020 116 949.3

(51) Int. Cl. G06F 3/0354; G06F 3/01; F16D 57/00

(52) U.S. Cl. CPC G06F 3/0354; G06F 3/016; F16D 57/002

(57) ABSTRACT

A method for operating an input device and an input device having an input element of the input device that is manually actuated for carrying out an input. A movability of the input element can be selectively delayed, stopped, blocked and enabled by means of a controllable magneto-rheological braking device. The mobility of the input element is adjusted in a targeted manner as a function of at least one input condition stored in the computer device. The input condition can have a movement parameter of the movement of the input element, which in turn comprises at least the direction, the speed and/or the acceleration of a movement.

The present invention relates to a method for operating an input device and such an input device. At least one input element of the input device is at least partially manually operated to perform an input.

Such input devices are widely used, for example, as mouse wheels in computer mice, control buttons on steering wheels of cars, smart devices or haptic telephone devices.

Input devices known in the prior art have the disadvantage that the methods known for control only give insufficient feedback for a user.

On the other hand, it is the object of the present invention to improve the operability of the input device. In particular, the ease of use and/or ergonomics should be improved and the user should be better supported when working with the input device. Preferably, the use of the input device and performing inputs should be made more intuitive.

This object is achieved by methods having the features of claims 1, 3, 5 and by an input device having the features of claim 31. Preferred developments of the invention are the subject of the subclaims. Further advantages and features of the present invention result from the general description and the description of the exemplary embodiments.

The method according to the invention is used to operate input devices, in particular for a computer device. At least one input element of the input device is at least partially manually operated for performing an input, in particular in the computer device connected to the input device. At least one mobility of the input element can be selectively delayed by means of at least one controllable magnetorheological braking device (i.e. preferably braked and in particular damped) and/or stopped and in particular blocked and/or enabled. In this case, the mobility of the input element is adapted in a targeted manner in particular by means of at least one control device and/or in particular by the computing device at least depending on at least one input condition stored in the computer device and/or in the input device. In particular, adjusting the mobility of the input element is carried out by means of actuation of the braking device. In particular, the input condition comprises a movement parameter of the input element.

Stopping within the meaning of this application includes in particular a very large delay of the mobility of the input element, which can only be overcome with great effort of the operator. On the other hand, a blocked input element is (practically) no longer movable by the user.

In particular, the movement parameter comprises the input condition, at least one direction and/or a speed and/or an acceleration of the movement of the input element. In addition, the movement parameter may preferably comprise an angular position.

The movement can be a linear movement, a swiveling movement and/or a rotary movement. It is additionally possible that a movement position, such as a rotation angle and/or a swivel angle, is used specifically as an input condition.

The invention presented here offers many advantages. Particularly advantageous is the adjustment of the mobility of the input element depending on the input condition. This allows the user to be supported in a targeted manner when working with the input device. In addition, the use of the input device becomes considerably more comfortable and performing inputs is made more intuitive. For example, an improvement in productivity and a reduction in the frequency of user errors can be achieved. In particular, the use of the movement parameter advantageously allows haptic feedback to the user. The user receives the feedback directly based on his input and/or movement. A visual check of the input on the operating device is not necessary. Advantageously, the user can directly sense how the input is processed, in particular by a connected computer device. People with diabetes may have a greatly reduced sensitivity to contact in the skin, for example in the fingers, whereby the control of a touch surface (touch-sensitive surface, for example the volume slider) is difficult to impossible. A haptic feedback will be perceived very well. In addition, the input conditions can also be stored and/or deposited directly on the input device in a memory unit or by a computer device arranged in the input device. Thus, the input conditions can be deposited directly in the user's device.

A particular advantage of the invention is also that an additional dimension is offered in which the mobility of the input element can be adjusted. A first basic dimension in which the mobility of the input element can be adjusted is known, for example, from WO 2018/215350 A1. There, the adjustment of the mobility of the input element depending on the rotation angle is described, so that rasterization points occur at certain distances and can be sensed (haptic feedback). By the invention it is now possible to store this dimension with another dimension of haptic feedback. For example, the mobility of the input element can be delayed more strongly or even blocked (second dimension) if the user rotates the control element between two rasterization points (first dimension) too fast or accelerates it too much or changes the direction suddenly.

In particular, the method is used to operate a computer mouse. The method can also be used to operate a rotary knob and/or a scroll wheel and/or a thumb roller and/or a joystick and/or a haptic telephone device and/or a smart device and/or other input device. The operation of technical equipment in vehicles, (such as a rotary controller; a turn/press controller; for infotainment, air conditioning, as a transmission selector switch, for navigation, for seat adjustment, in the steering or the steering wheel, for the operation of chassis adjustment, driving mode adjustment, distance adjustment, adaptive cruise control, trailer control . . . ), motor vehicles, aviation and aircraft, ships, boats, in agricultural machinery (tractors, combine harvesters, harvesting machines, other field machinery for agriculture, slope equipment . . . ), construction machinery and material handling machinery (forklift trucks, etc.), processing machinery and equipment used in industry or in medical or industrial installations.

The invention can also be used in the operation of or as an input device for washing machines, cooking/household appliances and devices, radios, photographic equipment and film cameras, VR (Virtual Reality) and AI (Artificial Intelligence) devices, Hi-Fi and television systems, smart devices, smart home devices, laptops, PCs, smart watches, in a crown wheel of wristwatches or as input device for computers or as a computer mouse or as a rotary wheel in a computer mouse or controllers, game consoles, gaming equipment, a rotary knob in a keyboard or other devices.

A computer or a mobile terminal device to which the input device is connected can serve as a computer device. The computer device may also be part of another device or machinery or vehicle. For example, the input device is then a thumb roller in the steering wheel of a vehicle. In particular, the computer device comprises at least one display device. In particular, the input device provides or is part of a human-machine interface (HID). In particular, the computer device comprises at least one graphical user interface (GUI) and, for example, a monitor or a display or the like. In particular, information and, for example, a performed input or the effects of a performed input are displayed graphically on the graphical user interface.

The input condition stored in the computer device can be permanently stored. The input condition stored in the computer device can also be determined dynamically, for example depending on a program or menu. The input condition can also be dynamically adjusted depending on the input, so that a mutual feedback or dependency can be achieved.

Preferably, a bidirectional communication between the computer device and the input device takes place. In particular, the input device can be actuated by the computer device and preferably vice versa. In particular, the computer device can actuate the braking device and can preferably adjust the braking effect. For this purpose, at least one algorithm and, for example, software or a driver or the like is stored in the computer device.

A manual operation of the input device is understood in particular to mean any at least partially muscle-powered operation. In this case, operation with the foot or with the head may be provided.

In the context of the present invention, a delay is understood in particular to mean braking and particularly preferably damping. Enabling or an enabling are understood in particular to mean an at least partial reduction of the delay and in particular a cancellation of the delay. In the case of a complete enabling of the mobility of the input element, the braking device is in particular inactive. Preferably, in the case of enabling, a magnetorheological medium is not affected by a magnetic field actively generated by the braking device. In the case of a complete enabling, the input element is in particular freely movable and, for example, freely rotatable. In addition to a rotary movement, a pushing operation and/or a pulling operation may be provided for the input element.

A further method according to the invention is used to operate an input device. At least one input element of the input device is at least partially manually operated for performing an input. The input element has at least two degrees of freedom. The mobility of the input element along a first degree of freedom is selectively blocked and/or in particular stopped by means of a magnetorheological braking device while the input element is operated along the second degree of freedom for input and/or after the input element has been operated along the second degree of freedom for input. Such a method may also be particularly advantageous as an embodiment of the method according to claim 1 or one of the other methods presented herein.

In particular, a rotatability of the input element is blocked by means of the braking device while the input element is pushed and/or pulled along the second degree of freedom. This offers, for example, the special advantage that during pushing or pulling (so-called push function or pull function) no accidental input is made by rotating. For example, pushing or pulling confirms an input that has previously been selected from a menu by rotating. If the input element were now to be accidentally rotated during pushing or pulling, an incorrect menu point could be confirmed. Additionally or alternatively, the rotatability of the input element can be blocked by means of the braking device if previously pushing on the input element and/or if previously pulling on the input element has taken place. Then no unwanted inputs can be performed afterwards. In particular, moving the input element along the second degree of freedom again unblocks the block. The block can also be automatically unblocked after a defined time.

In particular, a swiveling movement along the first degree of freedom is blocked by a linear movement along the second degree of freedom. For this purpose, the input element is preferably specifically pushed and/or pulled and/or swiveled around a pivoting point, which lies outside the input device itself. In particular, the linear movement takes place transversely to the axis of rotation.

Pushing and/or pulling is understood in particular to mean the operation of at least one button and/or switch and or a switching mechanism, which can be operated by pushing, pulling, swiveling and or turning. The operation can be detected in particular by additional sensors.

Advantageously, a second and/or other parallel user input is specifically suppressed. This is particularly advantageous if an input is to be performed in isolation from other inputs, such as rotary and/or swiveling movements.

A further method according to the invention is used to operate an input device. At least one input element of the input device is at least partially manually operated to perform an input. The mobility of the input element is selectively delayed, stopped, and in particular blocked and enabled by means of a magnetorheological braking device. The mobility of the input element is specified and/or influenced at least depending on a profile. The profile comprises, for example, at least two, three, four, five, ten, twenty, fifty, a hundred or more at least partially dependent or independent input conditions. In particular, the profile is at least partially specified by a user. Such a method may also be particularly advantageous as an embodiment of the method according to claim 1 or one of the other methods presented herein.

Advantageously, a mobility of the input element is controlled simultaneously depending on at least two input conditions. Advantageously, the profile may have a plurality or even a large number of input conditions. In particular, a profile contains all necessary input conditions for controlling a connected computer device. Advantageously, the profiles can be easily replaced. In addition, it is also possible that the input conditions of the profile can be adapted and adaptable together and depending on each other. The profile allows the transmission of input conditions for controlling the magnetorheological braking device. For example, game profiles for connected computer devices can be adjusted and transferred between different computer devices. In this case, a profile can, for example, specifically influence the strength and/or the intensity of the delay of the movement of the input device to change the braking effect of the magnetorheological braking device.

Particularly advantageously, the input conditions of the profile can be individually adjusted by at least one user interface by means of a computer device. For example, it is thus possible to select from a large number of predefined profiles and adjust them for individual needs. Here the adjustment takes place in particular depending on the movement parameters of the input element.

In at least one advantageous embodiment, a rasterization with stop points is generated within a range of movement of the input element by the braking device, which affects the mobility and movement of the input element. Due to the rasterization with the stop points, feedback for the user about the movement made is advantageously possible.

In at least one advantageous development, a distance between at least two adjacent stop points within the rasterization is at least partially changed depending on the movement parameter of the movement of the input element. Advantageously, improved feedback for a user of the input element of the input device is thus possible. It is also possible that the rasterization itself changes depending on the movement parameter of a movement.

Preferably, at least one stop point is skipped and/or omitted depending on the movement parameter of the movement of the input element. In addition, it is possible that individual stop points are omitted and/or skipped depending on a position of the input element. For example, fast movements can be carried out advantageously without disruptive stop points for the user. Advantageous operation is possible. In addition, it is possible that stop points in one direction of movement can be detectable by the user. As a result, the user advantageously receives feedback, for example, if an input is to be variable direction-dependently. In addition, it is thus possible that a rasterization is only noticeable to the user at low accelerations.

In at least one advantageous embodiment, the rasterization has between 3 and 200 stop points. Advantageously, the rasterization has in particular between 5 and 100 stop points.

Preferably, when wiping over program elements (so-called mouseover), the mobility of the input element is adjusted depending on a type of the wiped over program element and/or depending on an input condition for the wiped over program element.

In an advantageous embodiment, the input element is used for scrolling. In this case, the mobility of the input element is preferably adjusted and changed depending on the scrolling and in particular depending on the currently displayed page information and/or other displayed information. Scrolling takes place in particular by means of a rotational movement of the input element. Preferably, the input element is in the form of an input wheel. The input wheel is in particular a finger roller or a thumb roller or comprises at least one of these.

The mobility of the input element is in particular delayed (in particular damped) or stopped and in particular blocked if the currently displayed page information includes a previously set marker and/or a searched search term and/or a user notice. The user notice may include, for example, a command prompt and/or a warning or the like.

In an advantageous embodiment, the input element is used for spreadsheets. In this case, the mobility of the input element is preferably adjusted depending on at least one parameter of the cells of the spreadsheet, preferably the contents of the cells. The parameter can also affect the position of the cells of the spreadsheet.

In particular, the mobility of the input element is delayed and enabled when scrolling through a spreadsheet depending on a displayed cell height and/or cell width and/or an actual cell height and/or cell width. It is provided that a rasterization corresponding to the cell height and/or cell width is set for scrolling. In particular, the rotational movement of the input element is rasterized. In all embodiments, the rasterizing is carried out in particular by magnetorheological generation of stop points. In particular, the rasterizing is carried out by a targeted delay or blocking and a targeted enabling of the movement at certain intervals and/or at certain rotation angles.

It is preferred and advantageous that the mobility of the input element is adjusted depending on an activity of a program running in the background and/or depending on an operating state of an operating system of the computer device. For example, the mobility can be delayed or stopped and in particular blocked if the program in the background or the operating system outputs a user notice and, for example, a command prompt and/or a warning.

It is also advantageous and preferred that the mobility of the input element is adjusted depending on a zoom process. In particular, a different delay is set for zooming in than for zooming out. For example, a longer delay is carried out for zooming in than for zooming out or vice versa. It is advantageous to zoom in along a direction of movement with a delay. In this case, zooming out is advantageously carried out in an opposite direction of movement with a different delay than for zooming in. Advantageously, the user receives a haptic feedback directly by means of the zoom process.

In a particularly advantageous and preferred embodiment, the input element is used in a design program. It is preferred that the mobility of the input element is adjusted depending on a size and/or a priority of a component processed and for example moved by means of the input device.

It is possible and advantageous that in the case of an input in at least one input menu with inactive and active input fields, the mobility of the input element is adjusted depending on whether the input field is inactive or active. For example, in the case of inactive input fields the mobility is blocked or at least partially delayed.

It is possible and preferred that the mobility of the input element is specifically changed to provide a haptic confirmation of a previously performed input. Such confirmation or feedback can be performed with the invention in a much quieter and more targeted way than, for example, with a mechanically rasterized mouse. In addition, many different confirmations can be made with the invention by adjusting the mobility accordingly. For example, the confirmation is carried out by vibrating and/or rattling the input element.

According to the invention, rattling means in particular an alternating blocking and enabling of the mobility of the input element during an input or during a movement. The blocking and enabling is carried out at a high frequency. During vibrating, a higher frequency may be provided than during rattling. For example, a frequency of at least 10 Hz or at least 50 Hz or at least 100 Hz or more is provided. It may be provided that different types of confirmation are provided depending on the frequency level.

Preferably, in the case of an incorrect and/or implausible and/or critical input, the mobility of the input element is delayed or stopped and in particular blocked. Such an input can also be acknowledged with the confirmation described above, for example by vibrating and/or rattling. Such designs are particularly advantageous for sensitive inputs or medical devices. As a result, dangerous processes and, for example, critical machine movements or robot movements can be prevented or haptically indicated to the user.

In an advantageous embodiment, it is provided that after an input, the mobility of the input element is delayed or blocked until at least one further user input has been performed. The further user input is performed in particular by an input other than the delayed or stopped and in particular blocked mobility of the input element. For example, pulling or pushing the input element may be provided if the rotatability is delayed or stopped and in particular blocked. It is also possible that the further user input is performed by means of a different input device. The further user input may, for example, concern a confirmation of a particularly important or critical input.

In an equally advantageous and preferred embodiment, the input device is used in gaming (computer games). It is preferred that the mobility of the input element is adjusted depending on a scenario generated by means of the computer device. Preferably, the mobility of the input element is delayed more, the higher is a fictitious force to be applied in the scenario and/or the more difficult is an action to be performed fictitiously in the scenario. Advantageously, the delay is influenced continuously and in real time depending on the input condition and in particular the movement parameter.

In all embodiments, it is possible that the mobility and preferably a rasterization of the rotatability of the input element can be adjusted by at least one user input. Preferably, the adjustment made is stored in the computer device and/or in the input device.

For example, the normally provided rasterization can be coarsened and/or refined. A maximum delay of the mobility can also be adjustable. In particular, such an adjustment may be specific to a particular program.

In a particularly advantageous and preferred development, the input element comprises at least one input wheel. The input wheel is formed in particular as a mouse wheel, in particular of a computer mouse. In this case, the input is preferably performed at least by turning the input wheel. Preferably, the rotation of the input wheel can be specifically delayed, in particular damped, and stopped and in particular blocked and enabled by means of the braking device. Preferably, the input element, in particular the input wheel, also has at least axial mobility. For example, pushing and/or pulling of the input element and preferably the input wheel may be provided.

In all possible embodiments, it is particularly preferred that the mobility of the input element can be adjusted from freely movable to fully blocked. In this case, the mobility or rotatability is completely blocked within the scope of the present invention if a movement or rotation by a force that can be generated manually in an operational use of the input device is not possible. In particular, the braking device is suitable and designed to apply a decelerating torque between 0.001 Nm (basic torque without deceleration) and 0.02 Nm (maximum deceleration), in particular in mouse wheel applications. In addition, it is also possible in other fields of application to apply decelerating torques of at least up to 0.5 Nm and preferably of at least 2 Nm or at least 3 Nm. The basic torque and the maximum deceleration are advantageous in particular depending on the design of the input device and the magnetorheological braking device.

It is preferred that the mobility of the input element and in particular the rotatability of the input wheel can be switched or is switched between freely rotatable and stopped and in particular blocked with a frequency of at least 10 Hz and preferably at least 50 Hz. Also possible is a frequency of at least 20 Hz or at least 30 Hz or at least 40 Hz. A frequency of at least 60 Hz or at least 80 Hz or at least 100 Hz or approximately 1 kHz or an even higher frequency can also be provided. Also possible are frequencies of at least 120 Hz or at least 200 Hz or more.

For the rotatability of the input wheel, in particular at least 50 stop points and preferably at least 100 stop points can be set for each revolution. Also possible are at least 150 or at least 200 or at least 250 or at least 300 stop points. There may also be at least 350 or at least 400 stop points. The minimum adjustable rotation angle between two stop points is in particular a maximum of 10° and preferably a maximum of 5° and particularly preferably a maximum of 2°. The minimum adjustable rotation angle between two stop points can also have a maximum of 1° or a maximum of 0.5° or a maximum of 0.1°.

Preferably, the number of stop points is set depending on a number of provided input options. For example, the number of stop points is set depending on selection options, menu options and/or a number of pages or tabs or the like. In this case, a stop point is provided in particular by the fact that the rotation of the input wheel is at least temporarily selectively delayed and in particular blocked and then enabled again.

In at least one advantageous development a vibration, i.e. in particular a ripple (to vibrate) with a frequency of more than 100 Hz, is used as a warning signal by the magnetorheological braking device, so that a haptic perception and a perceptible sound are generated by the magnetorheological braking device. The current flow and/or voltage alternate between a positive (maximum) value, a zero value and a negative (maximum) value. Advantageously, the frequency of the warning signal can be between 50 Hz and 2 kHz or even higher up to 20 kHz. In this case, the current flow in the magnetorheological braking device is reversed, in particular periodically, so that the braking device vibrates and transmits the warning to the user. In addition, the braking device also generates an audible sound signal at such a high frequency. It may be advantageous not to place the alternating current signal and/or voltage signal symmetrically around the zero point, but to apply an offset. This changes in particular the perceptible feeling of the user. In particular, audible frequencies are output by the braking device. During movement of the input element, the vibration can be perceived, for example, by a finger and/or the hand of the user. A vibration generated by the braking device is transmitted by a supporting body of the input element or the braking device, for example, to at least a housing of the input device, which is in the form, for example, of a computer mouse. Thus fading can be produced which is acoustically perceptible, preferably for a human being.

Practically, the generation of a sound with the input element is possible. The sound or the acoustically perceptible fading may originate not only from the braking device itself, but from the vibration of the housing and many or almost all or all parts of the mouse.

In a specific embodiment, the vibration is passed from the holder of the mouse wheel or the brake to the housing of the mouse. The resulting oscillation of the mouse body creates the acoustic sound.

In the case of a ripple, the mobility of the input element may be blocked, at least in sections. In addition, the mobility of the input element may also be partially delayed and/or partially stopped. In particular, superpositions with other signals of the braking device are possible.

Preferably, voltages for operating the magnetorheological braking device are generated by a random generator, so that a torque and in particular a magnetic field strength jumps quickly back and forth between different strengths. As a result, the mobility of the input element can be adjusted as if, for example, sand were present on or in a bearing location or a bearing were heavily worn. The voltage range and current range of the random number generator can be varied. In particular in a narrow range, a movement of the input element can then feel as if a bearing friction is increased.

It is possible and advantageous that a rotation angle between the stop points is reduced when faster scrolling and/or a faster page change takes place. It is possible that a rotation angle between the stop points is increased when slower scrolling and/or a slower page change takes place. The reverse design is also possible.

In particular, the rotation angle of the input wheel is monitored by means of a sensor device. The sensor device is particularly suitable and designed to detect the rotation angle with a resolution of at least 1° and preferably at least 0.5° and particularly preferably at least 0.2° or preferably at least 0.1° or better.

In all embodiments, it is particularly preferred that the mobility of the input element can be or is adjusted in real time. In particular, the braking device is suitable and designed to change the delay by at least 30% within less than 100 milliseconds.

In particular, the delay can be changed within less than 10 milliseconds by at least 10%, preferably by at least 30% and particularly preferably by at least 50%. The delay can also be changed within less than 100 milliseconds by at least 100% or 500% or by ten times or a thousand times. Such real-time control is particularly advantageous for working with the input device.

It is possible that the input condition is also dynamically adjusted depending on the input. This makes it possible that the mobility of the input element is also adjusted by the input performed according to the principle of a feedback. Due to such a mutual dependency between the input and the input condition, a particularly advantageous adjustment of the rotatability and thus particularly intuitive operation of the input device is achieved.

It is possible and preferred that the control of the mobility of the input element can be learned. In particular, at least one machine learning algorithm is stored. For example, habits of a user with regard to performing inputs during the operation of a program are detected and stored in a memory device. For example, frequently used switching elements or menu points or the like can be detected and stored. As a result, the user can be supported when using the program again by targeted control of the mobility of the input element.

The braking device comprises in particular at least one field-sensitive magnetorheological medium and at least one field generation device for generating and controlling a field strength. The mobility in particular of the input element is specifically influenced by the field generation device and the medium.

The input device according to the invention serves in particular for carrying out the method described above. Also, the input device according to the invention achieves the previously set object particularly advantageously. In particular, the input device has the devices necessary for carrying out the method. In particular, the input device comprises at least those devices which were presented in the context of the description of the method according to the invention. In particular, the input device is suitable and designed to implement the method described above by means of an algorithm stored in the input device and/or in the computer device.

A braking device which is particularly advantageously suitable for use with the invention is also described in the patent application DE 10 2017 111 031 A1. The entire disclosure of DE 10 2017 111 031 A1 hereby becomes part of the disclosure content of the present application.

The braking device comprises in particular at least one wedge bearing and at least one coil arranged coaxially to the axis of rotation. As a result, the coil does not have to be placed next to the rollers of the wedge bearing, which means that the extent in the axial direction can be kept smaller for longer rollers. In particular, the input wheel is arranged radially around the wedge bearing.

The method according to the invention and the input device according to the invention are suitable for many applications, which are illustrated below by way of example:

For example, an intelligent reading mode in conjunction with at least one computer device is conceivable. For example, by operating the input element, it is zoomed to an easy-to-read size and then in particular when rotating always in the same way as a person would read a text passage. This means that the zoom jumps back to the beginning at the end of the sentence, and so on. The font always remains at the same height and preferably in the same reading area, so that the eye does not has to jump back and forth.

In addition, the method and the input device are particularly suitable for accepting and rejecting calls by mobile phones and/or haptic telephone devices. Thus, in the case of a call, a call can be accepted or rejected, in particular depending on a direction of rotation of an input element with a stop point. When rejecting the call, it is preferably possible to scroll through different messages by the input element, which are sent to the caller in particular by an operation.

In addition, it is conceivable to use the method and the input device for people with visual impairment and in particular blind people, who experience a corresponding feedback in particular in the form of a haptic morse code by the input device and preferably by the input element, which advantageously serves as an aid.

In addition, it is conceivable to use the method according to the invention and the input device in a thumb roller. In this case, the braking device of the thumb roller can be advantageously designed as a horizontal wedge bearing. The design is particularly narrow.

Advantageously, the roller bodies are implemented in this case as cylindrical rollers. The rollers have a small diameter (for example 1 mm) and advantageously a greater axial extent (for example 5 mm). A solenoid coil can be implemented either essentially horizontally (wound in the axial direction) or essentially in the radial direction (coil wound around the axis).

As in particular with other actuators for haptic feedback, the thumb roller preferably needs at least one sensor that advantageously measures at least one rotational movement. For this purpose, in particular at least one encoder or advantageously a magnetic ring with a Hall sensor can be used. In particular the same haptic feedback messages can be implemented in principle with the thumb roller, as advantageously with other input devices, which in particular can be implemented as a rotary knob with at least one wedge bearing. Due to the advantageously small installation space, preferably smaller torques can be generated. According to experience, this can be dispensed with in particular in the case of a small diameter, or large torques can be of secondary importance.

The thumb roller may advantageously also have a push function (push and hold), in which the thumb roller is advantageously pushed. This can be used in particular to confirm a function and/or to switch (on/off) and/or in particular as a return function. Advantageously, any other function can also be defined, for example by the customer, such as answering or hanging up the call.

An input device, which is advantageously implemented as a thumb roller, can also be used, for example, as a mechanical on/off switch (turning), and/or preferably for answering the smartphone or for hanging up. Here, increased functional reliability with regard to incorrect operation can be achieved by the method and the input device compared to a slider or a software switch.

In addition, applications are conceivable in which haptic feedback from an input device implemented as a mouse (or from a program) increase working speed and/or advantageously help to avoid errors. This can be particularly advantageous for long lists, such as spreadsheet programs (for example Excel) and/or word processing programs (for example Word). Here there are many different advantageous application cases (individual application cases can be implemented alone or in any combination with each other):
A scroll wheel as an operating element stops briefly in particular at preferred points, for example for important data, totals, at the end of lists or chapters, for headings, in Word for words marked in red (in particular misspelled) and/or at the end of files, etc.
When using a search function, the cursor advantageously jumps to the next search result when scrolling with an input element. This accelerates in particular searching data in large lists and files.
Advantageously, a mouse wheel stops at cells that are assigned a function (for example programmed cells). In particular, it can THUS be prevented that programmed cells are accidentally cleared and occupied by a number.
In addition, the application may also be advantageous for formatted cells. The pointer jumps in particular to cells of the same formatting and/or remains advantageously in cells of certain formatting.
In particular, when scrolling slowly through at least one operating element, it is advantageous to scroll only a little further in a file and, for example, more with fast scrolling. In particular, this can be indicated by a larger raster when turning the mouse wheel as an input element.
In particular when scrolling through Excel lists, the raster points are at a fixed cell spacing (adjustable) in order to advantageously get a feeling of the length of the list.
In particular when scrolling through an Excel list, a pre-programmed stop can be set in the case of sums or certain important results.
The rasterization spacing changes in particular depending on the position in the file. This makes navigation in a file advantageously easier. For example: If the spacing of the rasterization in the vicinity of certain positions (new section, heading, totals, end, etc.) is particularly smaller or an input element in the form of a mouse wheel can be rotated with more difficulty and thus indicates, for example, that this area in particular is being approached. As a result, a user knows in particular before reaching this position, for example, that he is approaching it and not only in particular when he encounters it. This is particularly advantageous for people with visual impairments.
If several people are working on the same file (for example in Word), it is possible that errors are advantageously avoided in particular with haptic feedback, since in particular changes are not overlooked so quickly. For example, a mouse wheel stops in the event of changes by another person, for example when scrolling through the file.
In the start menu of programs, in particular system programs of computer systems, for example the most frequently used programs are displayed as tiles higher up. The adaptive mouse wheel can be used to brake more strongly, in particular in these programs.

In addition, many possible advantages are derived from an input device in the form of a mouse, in particular with bidirectional communication:
Error messages in particular can be indicated haptically (for example by any type of feedback, for example vibration)
In particular, events can be indicated, for example E-mail input etc.
In particular in the case of an input into a computer device, such as by clicking on a button/link etc., the user advantageously receives feedback. This prevents multiple openings of a program, in particular if it does not open immediately or, for example, when sending an e-mail, etc.
Furthermore, the mouse can also advantageously be used as a learning aid for new programs, tutorials, and computers in general, for example: A user receives in particular at least one haptic feedback, if in the tutorial, for example, something is done incorrectly or correctly. In particular, this makes it easier to get started with new programs. A user may be able to learn more easily, in particular if he receives feedback in some form.
In addition, it is conceivable that a mouse itself learns as an input device: The software then remembers in particular movement patterns of the input element and uses them for the advantageous internal derivation in particular of control structures and commands (artificial intelligence).

In addition, the following applications in computer games/games applications are conceivable:
The habits of the user and can be supported, advantageously when searching, in particular by a stop at frequently used button icons, links, etc.
In addition, it is conceivable to incorporate at least one vibration as an additional haptic response.
In addition, advantages of bidirectional communication in the case of CAD programs are also possible and conceivable:
In particular, easier tagging through haptic feedback, in particular when reaching a contour, etc.
An advantageous error display in the event of unauthorized constructions, for example if areas or contours intersect, or a hole goes too deep.
When adjusting values, for example, the scroll wheel stops advantageously in particular when reaching minimum and maximum values or unauthorized values, etc.
When zooming, the resistance is advantageously not the same when zooming in, in particular as when zooming out.
In particular, the input device can be implemented as a learning aid through haptic feedback.
In particular when moving large parts with the mouse, a joystick, etc., for example more resistance opposes this. The scroll wheel is advantageously delayed, or in particular the resistance of the mouse on the surface (for example in particular by, for example, at least one ball on the underside (Databot mouse). Thus, for example, advantageously the size of parts can be advantageously felt.

In addition, there are also many advantages in gaming or computer games:
The resistance of the mouse wheel/joystick changes in particular depending on the game situation. For example, when driving large vehicles, resistance increases, for example.
For example, the devices can be adjusted for real systems (for example the joystick of an aircraft in the flight simulator: In particular, different types of aircraft have different resistances in the input device and in particular in the joystick).
In particular, an additional response of the system by vibrations (ripple) is possible.
Football game: A resistance of the controller increases in particular when a user is in possession of the ball, for example.
Simulation (agriculture): The controller changes in particular depending on the surface, for example soil, asphalt, sand and/or etc.
Car racing game: It may be possible to play with a steering wheel with at least one haptic feedback, in particular by at least one input device. In particular, for example, there may be a haptic thumb wheel in the steering wheel, for example, to change radio stations, be taken into account. In particular, the controller can also be changed depending on the surface. This can be particularly the case with a steering wheel application. In particular, a gear change with an input device is conceivable, which comprises in particular at least one movement of a thumb wheel and/or a scroll wheel.
In particular, a use as a learning program for driving schools is possible and conceivable.
Handicap for good gamers: Good players receive in particular a more difficult input device, which is, for example, at least implemented as a mouse and/or at least as an input device on the mouse. The haptics work in particular against the player, so that he has a disadvantage in particular relative to worse players. In this way, the “ability” of different players can be advantageously adjusted relative to each other.

In addition, an advantageous use of the method and the input device is also advantageous for automobiles, in particular in the form of a thumb roller on the steering wheel or preferably a turn and press actuator is conceivable, which may also be associated with the following advantages:
With a haptic thumbwheel in particular changing radio stations and/or advantageously adjusting the volume.
In particular, the input device can be used for changing a clock, also advantageously mechanical clocks with, for example, the turn and press actuator (advantageously as the adjusting wheel/crown in mechanical wristwatches), for example light rasterizing for each minute, stronger resistance at five minutes, more at ten, 15, 30 and 60 minutes.
An intuitive application to simplify the operating complexity is also possible, for example in the case of a call, the thumb roller may be used first to answer or reject the call. Turning up accepts in particular, turning down advantageously hangs up and/or vice versa. This can be indicated in particular by for example displays illuminated by LEDs (green)—Answer: “upwards”; “red”-Reject: “downwards”). If the user has answered the call in particular, the volume can be adjusted during the conversation, in particular with the same thumbwheel. The operation should be as simple and intuitive as possible. For this purpose, it can be advantageous to use variable displays, either for example with displays (for example Oled displays) or in particular with color displays with different colored LEDs (red and green as known colors for on-off; etc.).
Furthermore, it is conceivable to carry out a gear change, a change of driving mode, setting a cruise control, setting an ACC (Adaptive Cruise Control), with a haptic input device which is designed, for example, as a rotary knob or thumb roller.
In addition, the input device can be used for a faster telephone book search: For example, in particular the thumbwheel can be turned through the telephone book. Advantageously, for example, when reaching a new or a searched letter, in particular an initial letter, a user can advantageously experience a brief resistance. This can be advantageous because or if preferable a voice control often does not immediately understand the correct name. Preferably also at least a gesture control or the use of at least a touchpad and touch screen can in particular often lead to the wrong letter. With the thumbwheel you can advantageously find and/or search for the correct name very accurately. In particular with additional haptic help, the search is particularly easier and advantageously faster. This can be particularly advantageous when used in vehicles, in order in particular not to be distracted from the road for a long time, particularly with one's attention.

In addition, the following general advantages can also be realized as possibilities:
A scroll wheel is particularly difficult to turn at the end of pages (advantageously stops), for example in particular at the end of the view, advantageously at a zoom maximum/minimum, in particular at the end of lists, etc.
In particular, it is partially blocked when visiting prohibited sites, for example as parental control on the Internet.
The rasterization of the scroll wheel can in particular be switched on and off and preferably at least one rasterization dimension can be changed particularly at the same time.
In particular, a rasterization width can advantageously be adjusted by the user as desired.
It is conceivable that folder and file sizes can be advantageously indicated at least by a resistance when moving. In particular, when scrolling through folders, the resistance can be greater in large folders and/or in particular advantageously smaller in small folders and individual files than, for example, a reference and/or preferably a preset default value.
For visually impaired persons, at least one haptic feedback can be of great advantage (if, in particular, the mouse pointer is no longer easily seen because it is too small, for example).
The mouse wheel can, for example, preferably change a scrolling behavior if the cursor, for example, approaches a desired (favored) point (or fixed points, at a constant distance, etc.).
In entertainment media, it may be conceivable that the mouse wheel advantageously stops when fast-forwarding and rewinding movies, songs, etc., advantageously every five minutes, for example, with each new scene, at the beginning of the next song and/or in playlists with frequently heard songs, etc.
The resistance advantageously changes when adjusting the volume. At least one input device stops for volume “O”, i.e. in particular no volume and in particular if, for example, an excessively high level is reached. If, in particular, there is at least a risk of hearing damage, the mouse wheel is particularly difficult to turn.
The same can also apply, for example, to a screen brightness. In the case of a preferred screen brightness, for example, a brief resistance or a brief delay of the control element by the braking device can advantageously stop and/or delay at least one movement.
Alternatively, for example, a haptic scroll wheel may be advantageously arranged at least on the keyboard, so that pages and documents, etc. can be scrolled through quickly, for example, particularly without having to take the hand from the keyboard. It can be both in the form of a rotary knob and a scroll wheel and/or a thumb wheel. These input devices are advantageously controlled, for example, by a wedge bearing with an axial coil, or advantageously by the classic wedge bearing, which has in particular a radial coil.
For example, the input device may also be advantageously usable by apps for switching through and in particular “through switching”. There may be a high resistance, in particular with preferred apps.
The input of musical notes into music notation programs can be particularly greatly facilitated: for example, an input wheel can latch at each note line. The resistance is particularly high for low tones and is advantageously lower in particular for higher tones. In this way, the pitch is advantageously felt on the mouse wheel and one preferably knows where one is on the note line.
In drawing programs: In particular, with a change in the settings, the resistance of a movable input device advantageously changes: if, for example, the line thickness is increased with the mouse wheel, at least one resistance increases, for example of a mouse wheel. Or in particular when zooming, the resistance is advantageously higher when zooming in on a view than when zooming out.
Advantageously during a search on the Internet or, for example, via a search engine, scrolling can become increasingly difficult, for example, the further away you are from an original search query. Thus, for example, unlikely hits are preferably at least haptically noticeable.
In particular, it may be advantageous when programming that a raster advantageously adapts to a syntax in particular, i.e. advantageously adapts to or orients to at least one programming language. It may, for example, advantageously remain at a loop beginning and/or end or there may be a brief resistance, for example.
Advantageously, for example, in the case of e-mail programs, in particular at least a mouse wheel may advantageously stop: in particular for each unopened mail, for mails with attachments, for mails to which replies have been made and/or for mails with high priority, etc.
Advantageously, different modes can be programmable, so that each user can advantageously implement his own ideas. For example, a simple app can be implemented to adapt individual haptic feedbacks.
In particular, a strength of the mouse wheel resistance is advantageously adjustable by pressing the mouse wheel: if, for example, a mouse wheel is preferably pressed, a menu is advantageously called up to be able to adjust the strength of the resistance, for example.
A scroll wheel according to the invention may advantageously also be applied to mobile phones or other mobile devices. For example, the volume on the mobile phone can be changed without having to look at the touch screen.
In addition, use with game consoles is conceivable.

In a preferred development, the input device or the control unit comprises a control device which is suitable and designed to brake the rotary movement of the control part by means of the in particular magnetorheological braking device depending on an operating condition of a motor vehicle. Preferably, the operating condition includes at least one driving mode and at least one stationary mode. The stationary mode includes in particular at least one charging operation for a traction battery of an at least partially electrically powered vehicle.

In particular, the control device is suitable and designed to automatically and preferably using a machine learning algorithm select and adjust or suggest a functional level depending on the operating state, which can be operated with the control part. In particular, the functional level includes at least one entertainment function. In particular, the entertainment function is selected depending on the stationary mode. In particular, the functional level includes at least one driver assistance function. In particular, the driver assistance function is selected depending on the driving mode.

It is preferred and advantageous that the control device is suitable and designed to automatically, and preferably using the machine learning algorithm, block and/or not propose a functional level depending on the operating state. In particular, depending on the driving mode, those functional levels are selectively blocked and/or not suggested which are suitable for distracting the driver and/or which are prohibited by law while travelling. In particular, it is possible to store in the control device function levels which are to be blocked and/or not suggested.

Such developments can be carried out purely as follows (individual features can also be implemented alone or in any combination with each other): Electric/hybrid vehicles require more time to refuel (charge) than internal combustion engine vehicles. Depending on the charging structure and battery, this can be several hours. Even with fast charging stations (800 volts), charging takes noticeably longer than when refueling with fossil fuel. A motor vehicle is equipped with many control elements, which are at least partially designed like the control part described herein. During the charging process (stationary mode), the adaptive (magnetorheological) control parts in the vehicle are haptically actuated in such a way that the driver can pass the time or work (setting entertainment functions). The automobile including the control parts then becomes an office or a gaming station. For example, a control part in the form of a rotary wheel or a thumb roller in the steering wheel or in the center console can be used as a computer mouse wheel, the head-up display, the dashboard display or the other (touch) displays can be used as a display unit, the lighting to produce effects and the voice input for dictating texts, for example. Even a multifunctional seat (its massage function) or the chassis can be included (for example air suspension of an automobile or truck) and recreate certain playing states more realistically. The turn signal, gear lever, (switch) rocker/pedal for the control element in games, the (by wire) pedals to control an automobile in a gaming game (for example Need for Speed . . . ), and the steering wheel, in particular in automobiles with steer by wire, or all together as a flight simulator operation/game. In this context, the haptics (force feedback), i.e. the force against displacement or the torque against angle can be variably adjusted and adapted according to the requirements (in particular by the control device which specifically actuates the braking device). The haptic feedback of the thumb roller in the steering wheel is extended so that for example in connection with an Office application (PC) pages can be scrolled through more easily, a brief force increase can be detected on the user's finger in the event of page breaks. The input wheel is harder to rotate (stops) at the end of pages, at the end of the view, at the zoom maximum/minimum, at the end of lists, etc. It is blocked when visiting prohibited pages (for example as parental control on the Internet). The rasterization of the input wheel can be switched on and off and the density of the rasterization can be changed. The raster width can be set by the user as desired. File folder sizes and file sizes are indicated by more resistance when moving. When scrolling through folders, the resistance is higher for large folders, lower for small folders and individual files. The thumb roller, which becomes a mouse wheel, can change its scrolling behavior when the cursor approaches a desired (favored) point (or fixed points, at a constant distance, etc.). If the mouse wheel is used for gaming, the torque should generally be reduced (for example <1 mNm, because the adaptive rotary wheel is used much longer than for adjusting a menu while driving an automobile, i.e. is more demanding. When driving an automobile or in driving mode, the control elements should be a little heavier (higher torque or force; for example 2 mNm), since the vehicle is exposed to vibrations and driving is a dynamic process (forces act from the outside). In this way, safe user inputs can be generated. The use of the control element while stationary or when charging the battery is an overall static process in which the control element is used for a long period and intensively, but in a quiet environment. Excessively high forces or torques lead to faster fatigue of the input elements (fingers, hand, foot) and sometimes to inflammation (for example tendon sheath inflammation) in the case of very intensive input. In addition, in games or office applications, the torque must be varied more finely and in multiple stages (more diversely) and with haptically different curve profiles than when operating an automobile. The modes are programmable, in particular when used as a non-driving-specific control element, so that each user can implement his own ideas. For this purpose, a simple app for adjusting individual haptic feedback can be implemented. The haptics in the vehicle can also be adopted from the game console at home or the PC in the office (for example settings are stored and adopted in the cloud). However, the haptics should return to a standard mode for driving-specific inputs so that the driver of the vehicle receives reproducible feedback for driving events, in particular if they are safety-relevant (for example cruise control, distance control, accelerator, brake . . . ). The above is also advantageous for the rear seats in the automobile. There, too, the adaptive rotary control for the transmission or the input devices for the air conditioning can be used haptically for input devices for playing. For example, children can use the existing controls multifunctionally during battery charging but also while driving and can thus pass the time. But the vehicle can also be used in the garage as a “game simulator” or as a “driving school simulator”, it does not have to be only when charging the battery. Such designs can also be used for other vehicles such as trucks, off-road vehicles, motorbikes, slope equipment, airplanes, bicycles . . . , i.e. vehicles that have control elements that can be adaptively adjusted.

The applicant reserves the right to claim an input device which is suitable and designed to be operated according to the method described herein.

Further advantages and features of the present invention result from the description of the exemplary embodiments, which are explained below with reference to the enclosed figures.

In the figures:

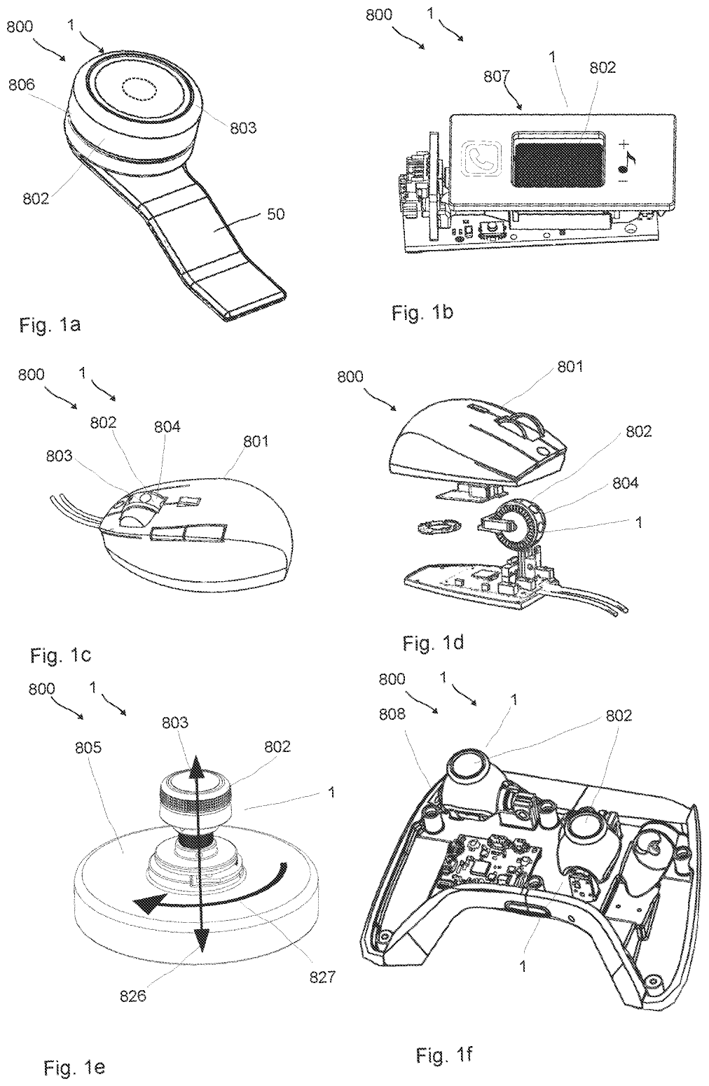

FIGS. 1a-1f show purely schematic three-dimensional views of input devices according to the invention;

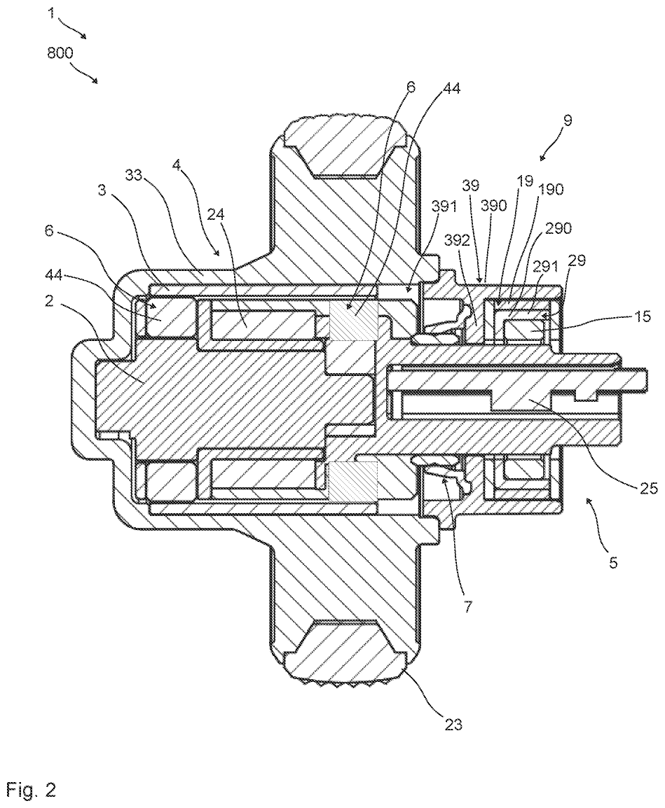

FIG. 2 shows a purely schematic representation of a braking device in a sectional side view;

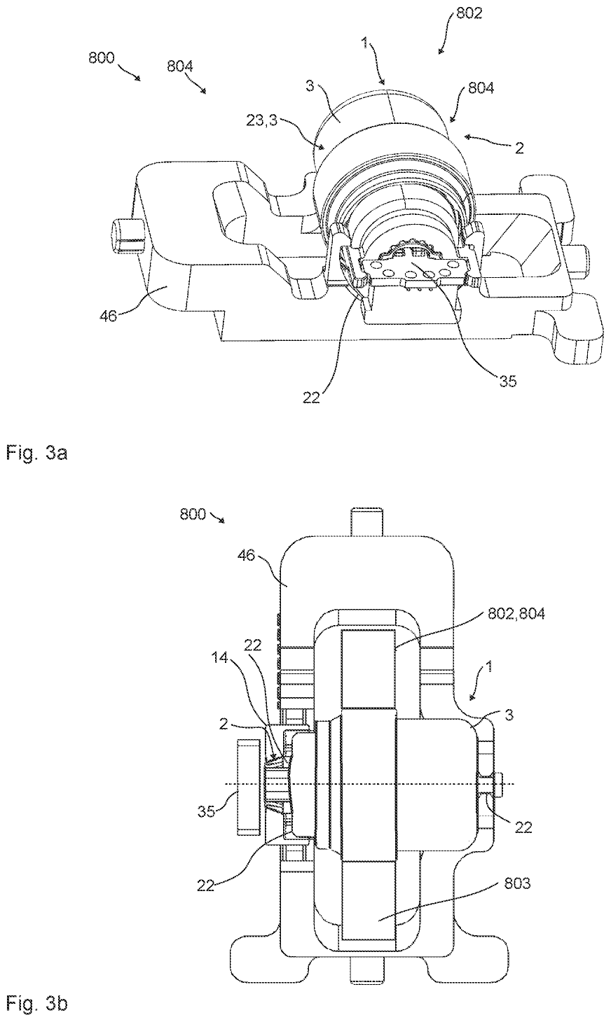

FIGS. 3a,b show a purely schematic representation and a plan view of a braking device for a mouse wheel as an input element of a computer mouse according to the invention as an input device;

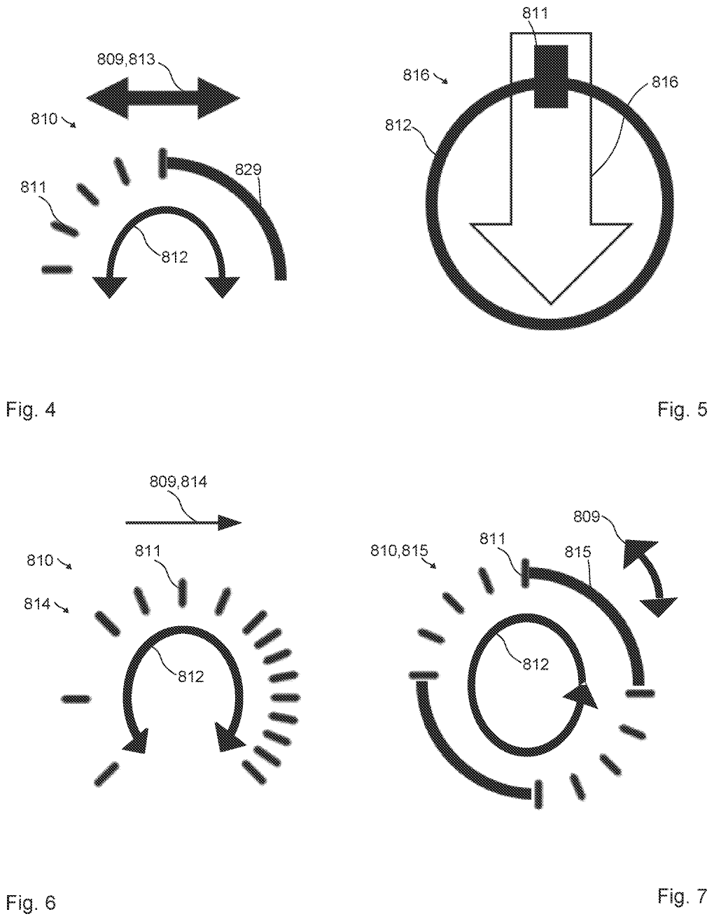

FIG. 4 shows a purely schematic representation of a haptic mode with a rasterization of the range of movement by the magnetorheological braking device and direction-dependent idling;

FIG. 5 shows a purely schematic representation of a further haptic mode with a blocked position of the mobility of the input element by the magnetorheological braking device in the event of an input by pressing the input element;

FIG. 6 shows a purely schematic representation of a haptic mode of a speed-dependent rasterization within the range of movement of the input element by the magnetorheological braking device;

FIG. 7 shows a purely schematic representation of a haptic mode with a rasterization within the range of movement of the input element, in which individual rasterization points are skipped;

FIGS. 9,8 show a purely schematic representation of a haptic mode of a high-frequency warning signal and a random current curve to control the mobility of the input element;

FIG. 10 shows a purely schematic representation of a user interface with a profile for controlling the mobility of an input element of an input device, which contains a plurality of variable input conditions; and

FIG. 11 shows a purely schematic representation of a haptic mode for simulation of a toggle switch.

In FIGS. 1a to 1f input devices 800 according to the invention are shown, which are equipped with magnetorheological braking devices 1 and are operated according to the method according to the invention. The input devices 800 here have input elements 802 in the form of input wheels 803.

FIG. 1a shows an input device 800 in the form of a control button 806. FIG. 1b shows an input device 800 in the form of a thumb roller 807. FIGS. 1e and 1d show a computer mouse input device 800 in the form of a computer mouse 801. The input wheel 803 is in the of a mouse wheel 804 here. FIG. 1e shows an input device 800 in the form of a joystick 805. FIG. 1f shows an input device 800 in the form of a gamepad 808. In FIG. 1e, a linear movement 826 and a swivel movement 827 are additionally indicated.

In FIG. 2, a braking device 1 of an input device according to the invention 800 with a rotary body 3 as input element 802 for setting inputs is shown. The operation is carried out here at least by turning the rotary body 3.

The rotary body 3 is rotatable by means of a bearing device 22, which is not shown here in detail, on an axle unit 2. The rotary body 3 can also be rotatably mounted on an axle unit 2 by means of a wedge bearing device 6 in the form of roller bearing here. However, the wedge bearing device 6 is preferably not or is only partially provided for support of the rotary body 3 on the axle unit, but is used for the braking device 4 presented below. Here, the roller bodies serve as brake bodies 44.

The axle unit 2 can be mounted on an object to be operated and, for example, in an interior of a motor vehicle or on a medical device or smart device. For this purpose, the axle unit 2 may have assembly means not shown in more detail here.

It may be provided here or in the following embodiments that the rotary body 3 is also movable on the axle unit 2 in the longitudinal direction or along the axis of rotation. Then an operation takes place both by turning and pushing and/or pulling or moving the rotary knob 3.

The rotary body 3 is sleeve-like here and comprises a cylindrical wall and an end face connected in one piece. The axle unit 2 protrudes from an open front side of the rotary body 3.

The finger roller 23 may be fitted with an additional part 33 indicated here in dashed form. This achieves a diameter increase, so that the rotatability is facilitated, for example with a finger-rotatable wheel of a computer mouse or game controller or a rotary wheel in the case of a computer keyboard thumb roller.

The rotary movement of the rotary knob 3 is damped here by a magnetorheological braking device 4 arranged in an accommodating space 13 inside the rotary knob 3. The braking device 4 generates a magnetic field with a coil unit 24, which acts on a magnetorheological medium 34 located in the accommodating space 13. This leads to local and strong crosslinking of magnetically polarizable particles in the medium 34. The braking device 4 thereby allows a targeted delaying and even complete blocking of the rotary movement. Thus, with the braking device 4, haptic feedback can be carried out during the rotary movement of the rotary body 3, for example by a correspondingly perceptible rasterization or by dynamically adjustable stops.

The medium here is a magnetorheological fluid, which includes an oil as a carrier fluid, for example, in which there are ferromagnetic particles 19. Glycol, grease, silicone, water, wax and viscous or low viscosity particles may also be used as a carrier medium without being limited to this. The carrier medium may also be gaseous and/or a gas mixture (for example air or ambient air) or the carrier medium can be dispensed with (vacuum, nitrogen, or air and for example ambient air). In this case, only particles (for example carbonyl iron) that can be influenced by the magnetic field are introduced into the accommodating space or the working gap. Mixing with other particles—preferably with lubricating properties—such as graphite, molybdenum, plastic particles, polymeric materials is possible. It may also be a combination of the mentioned materials (for example carbonyl iron powder mixed with graphite and air as the carrier medium). As a carbonyl iron powder without a (liquid) carrier medium, for example, the powder called CIP ER by the company BASF can be used with a minimum proportion of iron of 97%, without a coating and an average size of the particles of 5.1 μm, or CIP SQ-R from BASF with at least 98.5% iron content, 4.5 μm average size and an SiO2 coating. The different powders differ in the size distribution of the particles, in the coating, in the particle shape, etc.

The ferromagnetic or ferrimagnetic particles 19 are preferably carbonyl iron powders having spherical microparticles, wherein the size distribution and shape of the particles depends on the specific application. Specifically, a distribution of the particle sizes between one and twenty micrometers is preferred, but also smaller (<1 micrometer) to very small (a few nanometers, typically 5 to 10 nanometers) or larger particles of twenty, thirty, forty and fifty micrometers are possible. Depending on the application, the particle size can also become significantly larger and even penetrate into the millimeter range (particle balls). The particles can also have a special coating/jacket (titanium coating, ceramic, carbon jacket, polymer coating, etc.) so that they can better withstand or stabilize the high pressure loads occurring depending on the application. The particles can also have a coating against corrosion or electrical conduction. For this application, the magnetorheological particles can be made not only of carbonyl iron powder (pure iron; iron pentacarbonyl), but also, for example, of special iron (harder steel) or other special materials (magnetite, cobalt . . . ) or a combination thereof. Superparamagnetic particles with low hysteresis are also possible and advantageous.

For supplying and actuating the coil unit 24, the braking device 4 here comprises an electrical connection 14, which is formed, for example, in the manner of a circuit board or print or as a cable line. The connecting cable 11 extends here through a bore 12 running in the longitudinal direction of the axle unit 2.

The accommodating space 13 is externally sealed here with a sealing device 7 and a sealing unit 17 to prevent leakage of the medium 34. In this case, the sealing device 7 closes the open front side of the rotary body 3. For this purpose, a first sealing part 27 is in contact with the inside of the rotary body 3. A second sealing part 37 is in contact with the axle unit 3. The sealing parts 27, 37 are attached here to a supporting structure in the form of a wall 8.

The sealing unit 17 is in the form of an O-ring here and surrounds the axle unit 3 radially. The sealing unit 17 is in contact with the axle unit 2 and the rotary body 3. As a result, the part of the accommodating space 13 filled with the medium 34 is sealed against another part of the accommodating space 13.

In order to monitor the rotation position of the rotary body and to be able to use it to actuate the braking device 4, a sensor device 5 is provided here. The sensor device 5 comprises a magnetic ring unit 15 and a magnetic field sensor 25.

The magnetic ring unit 15 is diametrically polarized here and has a north pole and a south pole. The magnetic field sensor 25 in the form of a Hall sensor here measures the magnetic field emanating from the magnetic ring unit 15 and thus allows reliable determination of the rotation angle.

In addition, the magnetic field sensor 25 is preferably three-dimensional here, so that in addition to rotation, an axial displacement of the rotary body 3 relative to the axle unit 2 can be measured. This allows both a rotation and a push button function, or the push/pull 816 to be measured simultaneously with the same sensor 25. The braking device 1 may also be equipped with, for example but also only, with a rotation function and/or a push function.

The sensor device 5 is particularly advantageously integrated into the braking device 1. For this purpose, the sensor 25 is inserted into the bore 12 of the axle unit 2 here. The magnetic ring unit 15 surrounds the sensor 25 radially and is attached to the rotary body 3. This has the advantage that not length tolerances, but only precisely produced diameter tolerances come into play. The radial bearing clearances between the rotating rotary body 3 and the stationary axle unit 2 are correspondingly small and can also be easily controlled in series production.

Another advantage is that axial movements or displacements between the rotary body 3 and the axle unit 2 do not adversely affect the sensor signal since measurements are taken in the radial direction and the radial distance is essentially decisive for the quality of the measurement signal.

Another advantage is that the arrangement shown here is particularly insensitive to contamination and liquids since the sensor is arranged internally. In addition, the sensor in the bore 12 can be overmoulded, for example, with a plastic.

The braking device 1 is fitted with a shielding device 9 for shielding the sensor device 5 against the magnetic field of the coil unit 24 of the braking device 4. The braking device shown here differs from the previously described braking devices 1 besides by the shielding device 9 in particular also by the embodiment of the rotary body 3 and the additional part 33. The braking device shown here is, for example, a mouse wheel 804 of a computer mouse 801.

The rotary body 3 is in the form of a cylindrical sleeve here, and is completely surrounded on its outer side by the additional part 33. In this case, the additional part 33 closes the rotary body on that radial front side which faces away from the magnetic ring unit 15.

The additional part 33 has a radial elevation with a considerably larger diameter. As a result, the braking device 1 shown here is particularly well suited as a mouse wheel 804 of a computer mouse 801 or the like. The elevation here is designed with a groove, in which a particularly grippy material and rubber, for example, is embedded.

The braking device 1 shown here has two spaced apart wedge bearing devices 6. The wedge bearing devices 6 are each fitted with several brake bodies 44 arranged radially around the axle unit 2. The coil unit 24 is arranged between the wedge bearing devices 6. The brake bodies 44 are roller bodies here, for example, which roll on the inside of the rotary body 3 or the outside of the axle unit 2.

The magnetic ring unit 15 has a rotationally fixed coupling to the rotary body 3, so that the magnetic ring unit 15 is rotated when the rotary body 3 is rotated. The magnetic field sensor 25 is inserted into the bore 12 of the axle unit 2 here. The magnetic ring unit 15 surrounds the sensor 25 radially and is arranged axially at the end. The magnetic field sensor 25 is arranged with an axial offset to the axial center of the magnetic ring unit 15 here. This results in particularly high-resolution and reproducible sensing and in particular detection of the axial position of the rotary body relative to the axle unit 2.

The shielding device 9 comprises a shielding body 19 in the form here of a shielding ring 190. The shielding device 9 also comprises a separation unit 29, which is provided here by a gap 290 filled with a filling medium 291. In addition, the shielding device 9 comprises a magnetic decoupling device 39, which is provided here by a decoupling sleeve 390 and a decoupling gap 391.

The decoupling sleeve 190 comprises an axial wall 392 here on which the sealing device 7 is arranged. In addition, a bearing device 22 which is not shown in more detail here may be arranged on the axial wall 392.

The shielding body 19 is equipped with an L-shaped cross-section here and is made of a magnetically particularly conductive material. The shielding body 19 surrounds the magnetic ring unit 15 on its radial outside and on its axial side facing the coil unit 24. For magnetic decoupling, the gap 290 is arranged between the shielding body 19 and the magnetic ring unit 15 and is filled with a filling medium 291. The filling medium 291 has particularly low magnetic conductivity. In addition, the magnetic ring unit 15 is attached to the shielding body 19 by means of the filling medium 291.

Magnetic decoupling between the rotary body 3 and the shielding body 19 is achieved by the decoupling device 39. For this purpose, the decoupling sleeve 390 and a filling medium arranged in the decoupling gap 391 also have particularly low magnetic conductivity. The decoupling sleeve is rotationally fixedly connected to the shielding body 19 and the additional part 33 as well as the rotary body 3 here.

In order to be able to decouple the rotary body 3 even better from the sensor device 5, the rotary body 3 is arranged axially spaced apart from the decoupling sleeve 390 here. The end of the rotary body 3 which is facing the magnetic ring unit 15 does not protrude beyond the brake body 44. In addition, the rotary body 3 is axially offset or curtailed relative to the additional part 33. This results in a particularly advantageous magnetic and spatial separation of the rotary body 3 and the decoupling sleeve 390 in a very small installation space.

Since the magnetic field of the coil unit 24 for the braking effect flows over the rotary body 3, such an embodiment provides particularly good shielding. So that this magnetic flux affects the sensor 25 as little as possible, the rotary body 3 is terminated earlier in the axial direction and the magnetically non-conductive additional part 33 carries out the structural functions (bearing point, sealing points, etc.). The distance to the sensor 25 is thereby also larger and the assembly is lighter overall.

The rotary body 3 is made of a magnetically particularly conductive material. The additional part 33 and the decoupling sleeve 390, on the other hand, are made of a magnetically non-conductive material. For example, the shielding body 19 and the rotary body 3 are made of a p-metal. The components described here as magnetically non-conductive consist of plastic for example and have a relative magnetic permeability of less than 10.

The problematic fields, which can usually disturb the rotation angle measurement, are mainly the fields in the radial direction. These fields are shielded here with a shielding body 19 acting as a jacket made of suitable material, for example magnetically conductive steel. In addition, the magnetic field of the magnetic ring unit 15 can thus be strengthened. As a result, the magnetic ring unit 15 can be dimensioned smaller (thinner) and thus material, construction volume and manufacturing costs can be saved.

The construction is also improved according to the invention in that the wall thickness of the shielding body 19 is altered and a gap 290 is provided between the magnetic ring unit 15 and the shielding body 19. Due to the gap 290 between the ring 15 and the shielding body 19, the shielding and the reinforcement can be optimally adjusted. The material of the shielding body 19 is selected here so that it does not go into magnetic saturation, so that other magnetic fields are sufficiently shielded (a material in saturation allows magnetic fields to pass through in the same way as air, i.e. with the magnetic field constant μ0). With an advantageous design of the gap 290 between the ring 15 and the shielding body 19, the magnetic field does not close too strongly over the shielding body 19 and the field in the center of the sensor 25 is sufficiently homogeneous and is increased compared to a ring 15 the same or larger without a shielding body 19.

The dimensioning of the shielding device 9 shown here is particularly suitable for a mouse wheel 804 of a computer mouse 801 and has the following dimensions, for example. The shielding ring 190 is 0.5 mm thick, the distance between the shielding ring 190 and the ring 15 is also 0.5 mm, the width of the ring 15 is 2 mm and the diameter of the ring 15 is 8 mm. In this case, the possible interference field of the coil unit 24 is 140 μT, resulting in a possible error in the angle measurement of 0.1° (cf. geomagnetic field: approx. 48 μT in Europe).

In FIGS. 3a and 3b a further exemplary embodiment of an input device 800 according to the invention is shown. The input device 800 according to the invention shown here has a very small structural form and is particularly suitable for use in conjunction with a computer mouse 801.

FIG. 3a shows a perspective view here, while FIG. 3b shows a top view of the same exemplary embodiment. The input element 802 is in the form of an input wheel 803 here, on which the mouse wheel 804 is arranged. The input element 802 is in the form of a finger roller 23 here.

The axle unit 2 is externally mounted and supported on the rotary body 3 of the mouse wheel 804 by bearing devices 22 here. Thus, a particularly small structural form is possible here, which is mounted on the supporting body 46.

By means of the circuit board 35, the controllable magnetorheological braking device 1 is connected in particular to a computer device which is not shown. The mobility of the mouse wheel 804 is controlled and influenced by the magnetorheological braking device 1. At the same time, the mouse wheel 804 continues to serve as an input element 802 for the computer device. Depending on an input condition, the mobility of the input element 802 can be selectively delayed, stopped and enabled. The input condition itself may be deposited and stored here, in particular in the computer device or the input device 800 and/or the control element 802 itself. In this way, a user receives predefined and programmable haptic feedback via an input. In this case, an input of the user is detected by a sensor device 5, which can detect both a swiveling movement 827 and a linear movement 826. In addition, the sensor device 5 also detects the movement parameters, which include here the direction of rotation, the speed and the acceleration. A linear movement 826 of the mouse wheel 803 is produced here by depressing the mouse wheel 803.

In FIG. 4, a haptic mode of the method according to the invention is schematically shown here as an example for the input device 800, which is implemented as a mouse wheel 803. A haptic mode describes here a possible embodiment of the method for controlling the input element 802.

The reference characters assigned below to the individual features of the method refer to arrows and pictogram-like characters for visualization by way of example. This is intended to clarify the individual steps/features of the method for better understanding.

In the haptic mode shown here, the mouse wheel 804 operates directionally dependently 813 depending on the movement 809 in the range of movement 812. If the input element 802 implemented here as a mouse wheel 803 is rotated to the left, the braking device 1 generates a rotation-angle-dependent rasterization 810 with stop points 811, which the user perceives here as a surmountable resistance when turning. If the mouse wheel 803 is moved to the right, there is a freewheel 829 whereby the mouse wheel 803 is freely rotatable. This allows the user to receive direct feedback about the input.

Another haptic mode of the method is shown in FIG. 5. After a linear movement 826 of the mouse wheel 803 the mobility of the input element 802 is completely blocked by the magnetorheological braking device 1. This effectively avoids unintentional incorrect input by the user. The force in the stop point 811 is so great that a user cannot overcome it. The haptic mode is also known as pushing and blocking 816.

In FIG. 6, another haptic mode is shown. The rasterization 810 in the range of movement 812 is changed here speed-dependently 814 or acceleration-dependently 814. With a rapid rotation of the mouse wheel 803 by the user, a distance between two adjacent raster points 811 changes speed-dependently 814. For the movement 809 shown, the distance between the stop points 811 decreases with increasing speed, which the user perceives when turning.

In FIG. 7, a further embodiment of the method is shown as a haptic mode. The input element 802 is freely rotatable here, so that there is an infinite range of movement 812. In the present case, individual stop points 811 of the rasterization 810 are skipped 815 if there is a high acceleration of the input element 802.

The range of movement 812 of an input element 802 may be variable and in particular adjustable depending on the haptic mode. It is advantageous that adjusting the mobility and haptic feedback for the individual needs of a user or depending on a use or a program is possible.

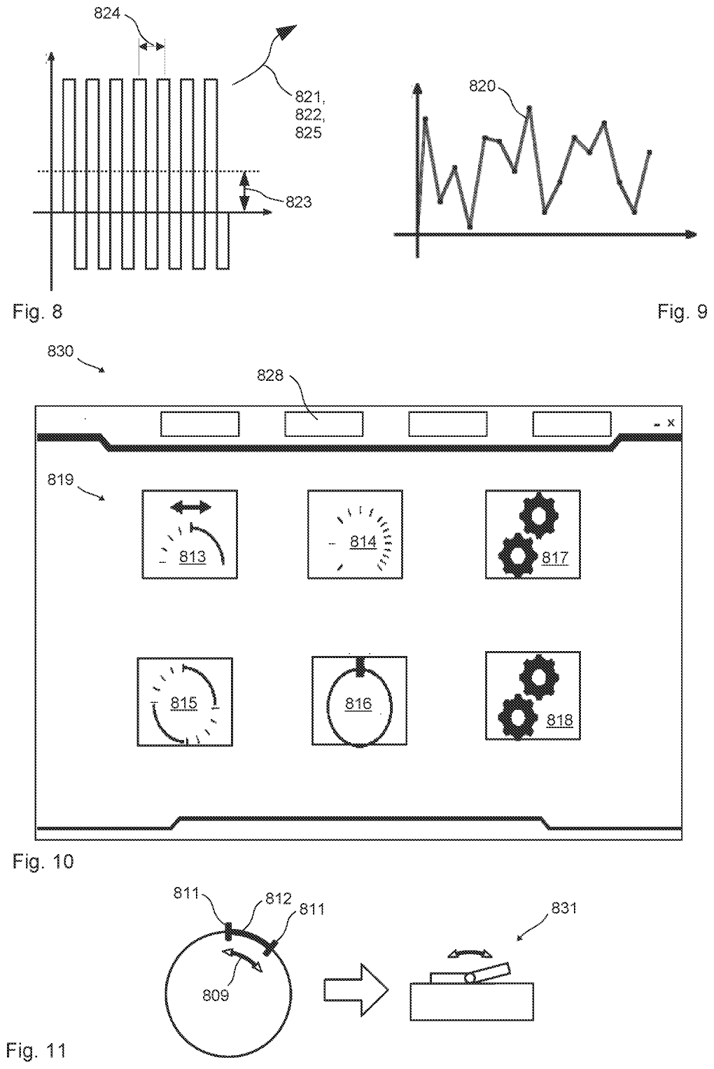

In FIG. 8, another haptic mode of the method is shown. Here, the braking device is actuated with a current and/or voltage signal with a frequency 824 of 100 Hz. The sign of the frequency signal varies. This gives a user haptic feedback in the form of vibration 825. A proportion of the positive and negative current flow is distributed asymmetrically 823. This leads to a change and at the same time to an advantageous perception of vibration 825 by the user. Due to the high frequency, an audible tone 821 is generated by the braking device 1. This haptic mode is advantageously suitable for emitting an audible warning signal 822 to the user.

The haptic mode shown here in FIG. 9 is based on actuation of the braking device 1 with a random current signal 820. As a result, for example, the wear of a bearing or, for example, sand in a gearbox can be displayed here for a user.

In FIG. 10, a possible user interface 830 is shown, by which the individual haptic modes can be variably combined into a profile 819. The user interface 830 may have a plurality of setting levels 828. A user can adjust the actuation of the braking device 1 depending on the direction 813 and the speed 814 and acceleration 814. In addition, the input conditions for skipping 815 and pushing and blocking 816 can also be adjusted. Profiles can be stored individually 817. In addition, it is possible here to use preset profiles 818, for example of other users, in particular program-specifically.

FIG. 11 shows a haptic mode with which a mechanical toggle switch 831 can be simulated with respect to the haptics during operation. The input element 802 can only be turned over a small or predetermined range of movement 812 or angular range and simulates a toggle switch 831, such as was installed for example in old stereo systems.

In all embodiments, the input device can be supplemented by an acoustic or visual output. The acoustic output can also be generated by the braking device itself.

In all embodiments, the input device can also be expanded by sensors, which are connected directly or indirectly (WLAN, Bluetooth . . . ) to the user (pulse or heart rate monitor, blood pressure, stress level . . . ) and/or can detect the environment (image recognition, ultrasound, laser, LIDAR, microphone . . . ) and from the information obtained from it and analyzed (environmental information, user information) can change the haptics of the input device.

### REFERENCE CHARACTER LIST

| | | | |
|---|---|---|---|
| 1 | braking device | 390 | decoupling sleeve |
| 2 | axle unit | 391 | decoupling gap |
| 3 | rotary body | 392 | axial wall |
| 4 | braking device | 800 | input device |
| 5 | sensor device | 801 | computer mouse |
| 6 | wedge bearing device | 802 | input element |
| 7 | sealing device | 803 | input wheel |
| 8 | wall | 804 | mouse wheel |
| 9 | shielding device | 805 | joystick |
| 11 | connecting line | 806 | operating knob |
| 12 | bore | 807 | thumb roller |
| 13 | accommodating chamber | 808 | gamepad |
| 14 | connection | 809 | movement |
| 15 | magnetic ring unit | 810 | rasterization |
| 17 | sealing body | 811 | stop point |
| 19 | shielding body | 812 | range of movement |
| 21 | core | 813 | direction dependent, |
| | | | direction dependency |
| 22 | bearing device | 814 | speed dependent, |
| | | | acceleration dependent |
| 23 | finger roller | 815 | skipping |
| 24 | coil unit | 816 | pushing and blocking |
| 25 | magnetic field sensor | 817 | individual |
| 27 | sealing part | 818 | default/external profile |
| 29 | separating unit | 819 | profile |
| 33 | auxiliary part | 820 | random current |
| 34 | medium | 821 | alert |
| 35 | printed circuit board | 822 | warning signal |
| 37 | sealing part | 823 | asymmetry |
| 39 | decoupling device | 824 | frequency |
| 44 | brake body | 825 | vibration |
| 45 | signal line | 826 | linear movement |
| 46 | supporting body | 827 | swiveling movement |
| 50 | console | 828 | adjustment levels |
| 190 | shield | 829 | idling, freely rotatable |
| 290 | gap | | |
| 291 | filling medium | | |
| 830 | user interface | | |
| 831 | toggle switches | | |

1-35. (canceled)

36. A method for operating an input device, the method comprising:
providing at least one input element of the input device that is at least partially manually operable for performing an input;
selectively delaying, stopping, and enabling at least a mobility of the input element by at least one controllable magnetorheological braking device; and
adjusting the mobility of the input element in a targeted manner at least depending on at least one input condition, wherein the input condition has at least one movement parameter.

37. The method according to claim 36, wherein the movement parameter includes at least one of a speed or at least one direction or an acceleration of a movement of the input element.

38. The method according to claim 36, wherein the input element has at least two degrees of freedom, and the at least one input element of the input device is at least partially manually operated for performing an input; and
blocking at least one mobility of the input element along a first degree of freedom in a targeted manner by means of the at least one controllable magnetorheological braking device, while the input element is operated for input along the second degree of freedom and/or after the input element has been operated for input along the second degree of freedom.

39. The method according to claim 38, further comprising blocking a swiveling movement along the first degree of freedom by a linear movement along the second degree of freedom.

40. The method according to claim 39, wherein the linear movement takes place transversely to the axis of rotation of the swiveling movement.

41. The method according to claim 36, wherein at least one input element of the input device is at least partially manually operated for performing an input;
selectively delaying, stopping, and enabling at least one mobility of the input element by at least one controllable magnetorheological braking device; and
at least one of predetermining or influencing the mobility of the input element at least depending on a profile, which comprises at least two or more at least partially dependent input conditions, which are at least partially predetermined by a user.

42. The method according to claim 41, wherein the profile is in particular individually adaptable by a user interface of a computer device.

43. The method according to claim 41, wherein the profile is adapted based on environmental information or user information.

44. The method according to claim 36, further comprising generating, within a range of movement of the input element, a rasterization with stop points by the braking device depending on at least one movement parameter, which affects the mobility and a movement of the input element.

45. The method according to claim 44, wherein the rasterization is generated depending on the range of movement.

46. The method according to claim 44, wherein a distance within the rasterization between at least two adjacent stop points of the rasterization is at least partially altered depending on the movement parameter of the movement of the input element.

47. The method according to claim 44, wherein at least one stop point is at least one of skipped or omitted depending on the movement parameter of the movement of the input element.

48. The method according to claim 44, wherein the rasterization has between 2 and 200 stop points.

49. The method according to claim 36, wherein the input element is used for scrolling, and the mobility of the input element changes depending on the scrolling and in particular depending on the scrolling direction.

50. The method according to claim 36, further comprising adjusting the mobility of the input element depending on an activity of a program running in the background and/or depending on an operating state of an operating system of a computer device.

51. The method according to claim 36, further comprising adjusting the mobility of the input element depending on a zoom operation and wherein zooming in along a direction of movement is carried out with a delay and zooming out in an opposite direction of movement is carried out with a different delay than for zooming out.

52. The method according to claim 36, wherein in the case of an input in at least one input menu with inactive and active input fields, adjusting the mobility of the input element depending on whether the input field is inactive or active.

53. The method according to claim 36, further comprising altering the mobility of the input element to provide haptic confirmation of a previously performed input.

54. The method according to claim 36, wherein in the case of at least one of an incorrect or implausible or critical input, delaying or blocking the mobility of the input element.

55. The method according to claim 36, further comprising delaying or stopping, after an input, the mobility of the input element until at least one further user input has been carried out.

56. The method according to claim 36, wherein:
the input device is used for gaming, and the mobility of the input element is adjusted depending on a scenario generated by means of the computer device; and
the mobility of the input element is increasingly delayed relative to a higher is a fictitious force to be used in a scenario of a game and/or the more difficult an action is to be performed fictitiously in the scenario of the game.

57. The method according to claim 36, wherein the mobility can be adjusted by a user input.

58. The method according to claim 36, wherein:
the input element has at least one input wheel;
the input is carried out at least by turning the input wheel; and
the rotation of the input wheel can be selectively delayed and stopped and enabled by means of the braking device.

59. The method according to claim 58, wherein the rotation of the input wheel can be adjusted from freely rotatable to fully blocked for the manually generated operating force occurring at the input device.

60. The method according to claim 58, wherein the rotatability of the input wheel can be switched between freely rotatable and blocked with a frequency of at least 10 Hz.

61. The method according to claim 44, wherein the number of stop points is adjusted depending on a number of input options provided.

62. The method according to claim 36, wherein voltage and current for operating the magnetorheological braking device are generated by a random generator so that a vibration jumps rapidly between different strengths.

63. The method according to claim 36, further comprising adjusting the input condition dynamically depending on the input, so that the mobility of the input element is also adjusted by the input made according to the principle of a feedback.

64. An input device for carrying out the method according to claim 36.
